(19) United States
(12) Patent Application Publication
(10) Pub. No.: US 2024/0149645 A1
(43) Pub. Date: May 9, 2024

(54) RECREATIONAL VEHICLE AND AIR CONDITIONING ASSEMBLY

(71) Applicant: Haier US Appliance Solutions, Inc., Wilmington, DE (US)

(72) Inventors: Richard Dustin Henderson, La Grange, KY (US); Cody Michael Ratchford, Louisville, KY (US)

(21) Appl. No.: 17/983,838

(22) Filed: Nov. 9, 2022

(51) Int. Cl. B60H 1/32; B60H 1/00

(52) U.S. Cl. CPC B60H 1/3227; B60H 1/00364; B60H 1/32281

(57) ABSTRACT

A recreational vehicle air or air conditioning assembly may include a modular enclosure, a refrigerant circuit, and a water line. The refrigerant circuit may be mounted within the modular enclosure. The refrigerant circuit may include an evaporator. The water line may be directed at the refrigerant circuit in fluid isolation from the evaporator to guide a cooling water flow across a portion of the refrigerant circuit apart from the evaporator within the modular enclosure.

### FIELD OF THE INVENTION

The present subject matter relates generally to recreational vehicles, and more particularly to air conditioning assemblies for the same.

### BACKGROUND OF THE INVENTION

Certain recreational vehicles include an air conditioning system, referred to generally as a recreational vehicle air conditioner (RVAC), for maintaining a comfortable temperature within the passenger compartment. The air conditioners are typically mounted on the roof or another exterior location of the recreational vehicle and utilize a sealed system for circulating refrigerant between an indoor and outdoor heat exchanger to facilitate heat transfer. For example, the indoor heat exchanger is positioned within an indoor portion of the RVAC and is in fluid communication with the passenger compartment through an opening in the roof. The outdoor heat exchanger is positioned within the outdoor portion and is separated from the indoor heat exchanger by a partition or divider.

One of the biggest complaints with current RVAC systems is that the RVAC does not provide enough cooling. In other words, users are often dissatisfied with the cooling capacity of the RVAC. This is especially pronounced when the recreational vehicle is parked for an extended period of time (e.g., a campsite) and is forced to remain parked while being subjected to elevated temperatures. Nonetheless, the size and power constraints on most RVAC units prevents existing manufacturers from making perceivable improvements. These challenges become even more pronounced when using a modular RVAC system (e.g., mounted to the roof) that a designer or manufacture cannot optimize for a particular vehicle or space.

Accordingly, an improved air conditioner would be useful. More specifically, it would be advantageous to provide a recreational vehicle or air conditioning assembly with improved cooling capacity (e.g., in comparison to existing assemblies) without significantly impacting size or power use. It may be especially useful to provide such advantages in the context of a modular air conditioning assembly.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a recreational vehicle air conditioner is provided. The recreational vehicle air conditioner may include a modular enclosure, a refrigerant circuit, and a water line. The refrigerant circuit may be mounted within the modular enclosure. The refrigerant circuit may include an evaporator. The water line may be directed at the refrigerant circuit in fluid isolation from the evaporator to guide a cooling water flow across a portion of the refrigerant circuit apart from the evaporator within the modular enclosure.

In another exemplary aspect of the present disclosure, a recreational vehicle is provided. The recreational vehicle may include a ceiling defining an opening, a ceiling-mount indoor panel, a modular enclosure, a refrigerant circuit, and a water line. The ceiling-mount indoor panel may define an air inlet and an air outlet. The modular enclosure may be mounted to the ceiling-mount indoor panel. The refrigerant circuit may be mounted within the modular enclosure. The refrigerant circuit may include an evaporator. The water line may be directed at the refrigerant circuit in fluid isolation from the evaporator to guide a cooling water flow across a portion of the refrigerant circuit apart from the evaporator within the modular enclosure.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a recreational vehicle according to an exemplary embodiment of the present disclosure.

FIG. 2 provides a perspective view of a recreational vehicle air conditioner (RVAC) that may be used with the exemplary recreational vehicle of FIG. 1, with an outdoor cover removed for clarity.

FIG. 3 provides a perspective view of the exemplary RVAC of FIG. 2 with an indoor cover removed for clarity.

FIG. 4 provides a schematic view of a portion of an air conditioning system according to an exemplary embodiment of the present disclosure.

FIG. 5 provides a schematic view of a portion of an air conditioning system according to another exemplary embodiment of the present disclosure.

FIG. 6 is a schematic side view of the exemplary air conditioner of FIG. 2 mounted on a ceiling of a recreational vehicle according to an exemplary embodiment of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

The terms “upstream” and “downstream” refer to the relative flow direction with respect to fluid flow in a fluid pathway. For example, “upstream” refers to the flow direction from which the fluid flows, and “downstream” refers to the flow direction to which the fluid flows.

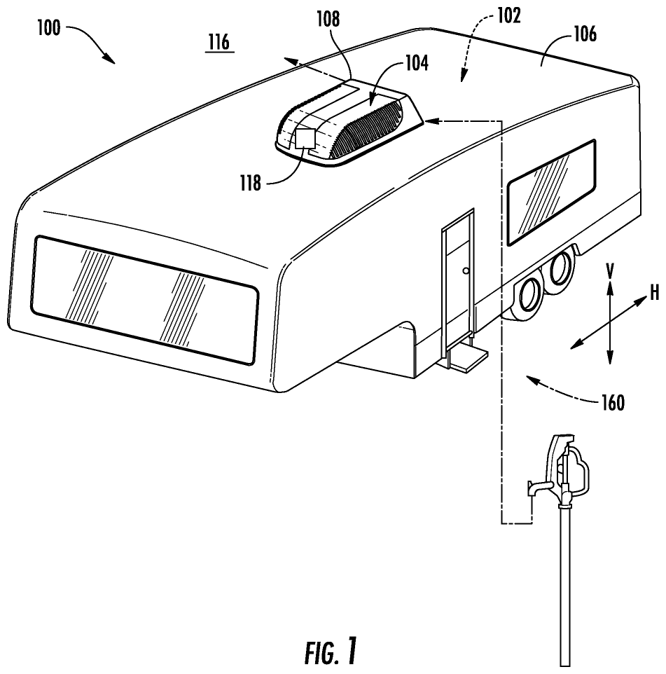

FIG. 1 provides a perspective view of an exemplary recreational vehicle 100 in accordance with the present disclosure. People may employ recreational vehicle 100 for a variety of purposes, including transportation, cooking, eating, sleeping, entertaining, and the like. As such, recreational vehicle 100 defines a passenger compartment 102, which may further include a bed, stove, table, restroom, or multiple compartments for storing items that passengers wish to take with them on their travels. Because people often spend significant time within the passenger compartment 102 of recreational vehicle 100, climate control of the passenger compartment is desirable.

Accordingly, an air conditioning system or air conditioner 104 may be mounted on recreational vehicle 100 to provide cooled air to the passenger compartment 102. Air conditioning system 104 is typically mounted to an outside surface 106 of recreational vehicle 100. This arrangement may be advantageous because a byproduct of operation of air conditioning system 104 is heated air, which has been passed over a heat exchanger to remove heat from the air circulating within passenger compartment 102. During certain operations, this heated air may be exhausted to the ambient air. As shown in the exemplary embodiment of FIG. 1, air conditioning system 104 may be mounted on an outer surface 106, such as the ceiling or top of recreational vehicle 100. Also as shown in FIG. 1, air conditioning system 104 may include a modular enclosure 108 having an outer grill that is positioned over and encloses the working components air conditioning system 104, e.g., to protect such working components from rain, wind, debris, etc. Although an exemplary recreational vehicle is illustrated, it should be appreciated that air conditioner 104 may be used in or with any suitable recreational vehicle.

In certain embodiments, recreational vehicle 100 further includes a controller 118. Controller 118 may control various operations within recreational vehicle, such as air conditioner 104. Controller 118 may be provided at any suitable location within recreational vehicle 100, and may be operably coupled (e.g., electrically or wirelessly coupled) to air conditioner 104. Further, controller 118 may be operably coupled to one or more sensor assemblies, such as a temperature sensor (e.g., thermistor, thermocouple, etc.), humidity sensor (e.g., hygrometer), etc., to detect a corresponding condition of passenger compartment 102 and transmit one or more signals according to the same, as would be understood.

In some embodiments, controller 118 includes one or more memory devices and one or more processors. The processors can be any combination of general or special purpose processors, CPUs, or the like that can execute programming instructions or control code associated with operation of recreational vehicle 100. The memory devices (i.e., memory) may represent random access memory such as DRAM or read only memory such as ROM or FLASH. In one embodiment, the processor executes programming instructions stored in memory. The memory may be a separate component from the processor or may be included onboard within the processor. Alternatively, controller 118 may be constructed without using a processor, for example, using a combination of discrete analog or digital logic circuitry (such as switches, amplifiers, integrators, comparators, flip-flops, AND gates, and the like) to perform control functionality instead of relying upon software.

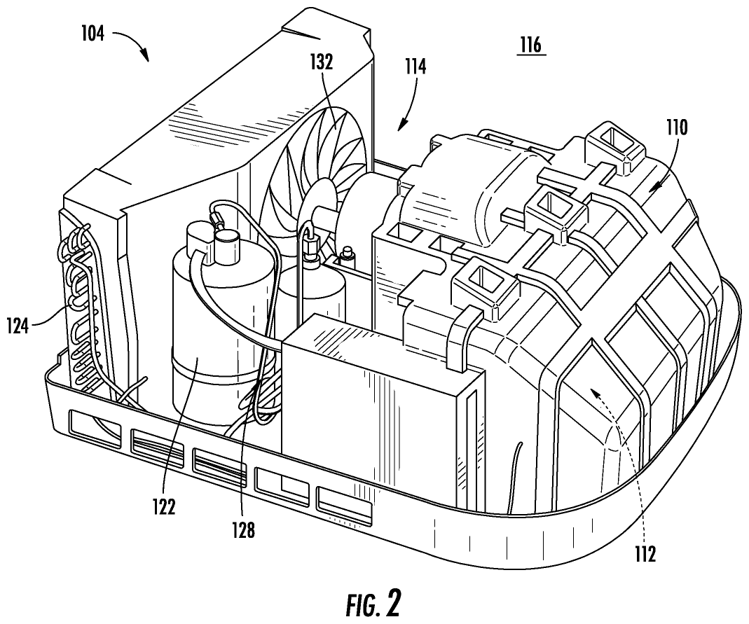

Referring now generally to FIGS. 2 through 5, the operation of air conditioning system 104 will be described in more detail according to exemplary embodiments of the present subject matter. In this regard, FIG. 2 illustrates a top, perspective view of air conditioner 104 of recreational vehicle 100 with outer grill of the modular enclosure 108 removed to reveal internal working components of air conditioner 104. As illustrated, air conditioning system 104 generally includes an indoor bulkhead or indoor cover 110 that divides air conditioning system 104 between an indoor and outdoor portion, such as in a packaged terminal air conditioner (PTAC) or a split heat pump system. Specifically, indoor cover 110 defines and indoor air plenum 112 and an outdoor air plenum 114. In this regard, indoor cover 110 generally shields the indoor components of air conditioning system 104 from the outdoor environment 116.

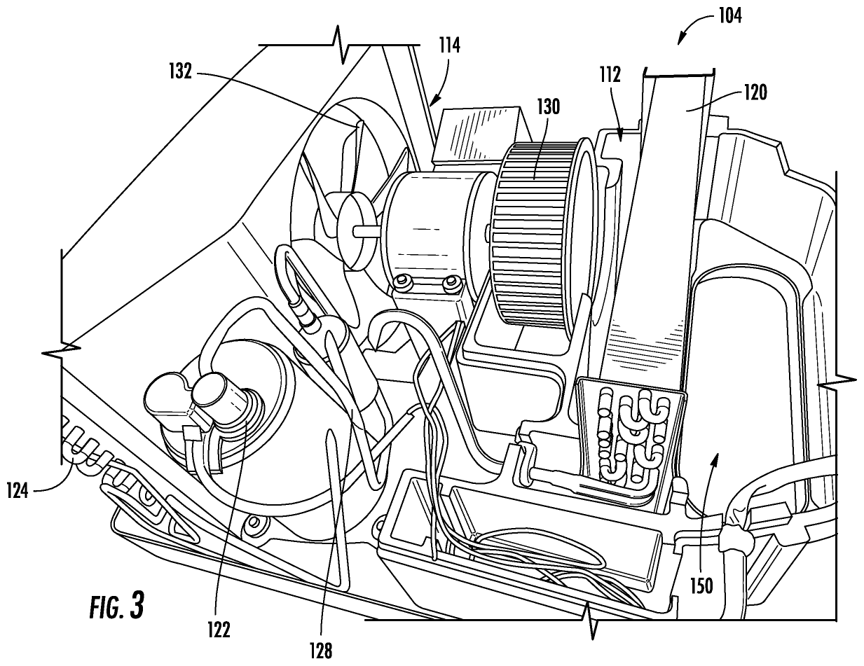

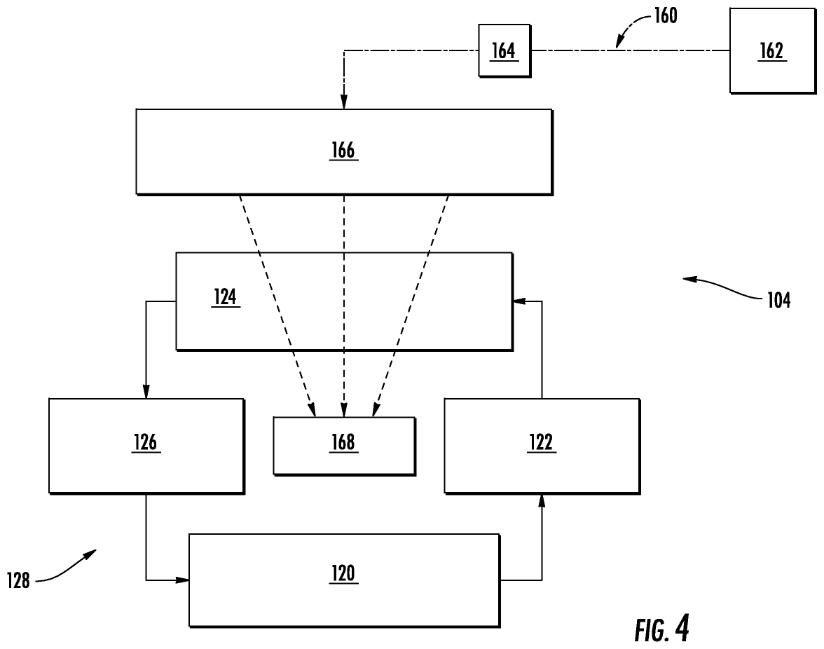

Referring now also to FIG. 3, indoor cover 110 is removed to reveal additional working components of air conditioning system 104. In addition, FIG. 4 illustrates a schematic view of air conditioning system 104. Relevant components of air conditioning system 104 will now be described. It should be understood that air conditioning system 104 generally includes a refrigerant circuit 128 defining one or more circulating refrigerant paths for treating air within an interior of an associated recreational vehicle 100. In this regard, for example, the refrigerant circuit 128 air conditioning system 104 may include a sealed system providing a refrigerant circulating between an evaporator or indoor coil 120, compressor 122, condenser or outdoor coil 124, and expansion device 126 (e.g., fluidly connected by one or more suitable pipes, tubes, conduits, etc.), as shown in the refrigerant circuit 128 of air conditioning system 104 in FIGS. 2 through 5. Refrigerant, also known as coolant, carries heat from the passenger compartment 102 of recreational vehicle 100 to the outdoors 116 (e.g., ambient area surrounding outer surface 106 of the passenger compartment 102). Refrigerant is useful because it changes states from a liquid to a vapor at convenient temperatures for a refrigeration cycle. One suitable refrigerant for use in refrigerant circuit 128 is 1,1,1,2-Tetrafluoroethane, also known as R-134A, although it should be understood that the present disclosure is not limited to such example and that any suitable refrigerant may be utilized. For example, according to an exemplary embodiment, the refrigerant may be R-410A or another refrigerant.

The refrigerant begins by passing through evaporator 120 in liquid form. Ambient air or air from the passenger compartment 102 may pass over evaporator 120, e.g., as motivated by an evaporator 120 air handler. More specifically, as illustrated, air conditioning system 104 may include an indoor fan 130 configured for urging a flow of indoor air. Because the liquid refrigerant is cold in this low-pressure state, it absorbs heat from the air passed over it, cooling the air for delivery to the passenger compartment 102. As the liquid refrigerant absorbs heat, it evaporates into a vapor. From there, the gaseous refrigerant is delivered to compressor 122, which increases the pressure of the refrigerant, thus raising its temperature well-above the ambient temperature outside of recreational vehicle 100. From compressor 122, the heated refrigerant is delivered to condenser 124. Air may pass over condenser 124, e.g., as motivated from a condenser 124 air handler. More specifically, as illustrated, air conditioning system 104 may include an outdoor fan 132 configured for urging a flow of outdoor air, thereby facilitating heat transfer from the heated refrigerant to the ambient air. In releasing this heat energy, the refrigerant condenses back into liquid form. Next, the refrigerant is delivered to expansion device 126, where the pressure of the refrigerant is reduced, thus decreasing its temperature. The cooled, liquid refrigerant is then delivered back to evaporator 120 to repeat the process.

It is noted that although a sealed system is described above (e.g., as a thermodynamic assembly), one of ordinary skill in the art would, in light of the present disclosure, understand that such a sealed system may be substituted for other suitable heat-exchange systems, such as a system relying on shape-memory alloys (SMA). For instance, a pair of discrete fluid circuits (e.g., a hot circuit and a cold circuit) each having a discrete volume of heat-carrying fluid (e.g., water, brine, glycol, air, etc.) may be separately connected to a compression unit—the compression unit housing a plurality of plate stacks each having one or more plates formed from one or more SMA material (e.g., copper-nickel-aluminum or nickel-titanium). Separate heat exchangers may generally be provided on the circuits in place of the evaporator and the condenser of a sealed system. In particular, a first heat exchanger may be provided on the cold circuit (e.g., in place of the evaporator) to absorb heat from the adjacent air and impart such absorbed heat to the heat-carrying fluid within the cold circuit. Thus, the first heat exchanger may also be referred to as an “evaporator” herein. Similarly, a second heat exchanger may be provided on the hot circuit (e.g., in place of the condenser) to release heat to the adjacent air from the heat-carrying fluid within the hot circuit. Thus, the second heat exchanger may also be referred to as a “condenser” herein.

The compression unit may facilitate or direct heat between the circuits. As an example, the compression unit may have four discrete plate stacks, each being separately compressed or released by a corresponding mechanical press or vice (e.g., hydraulic ram or electric actuator). During use, the plate stacks may be compressed and released (e.g., alternated between a compressed state or stroke and a released state or stroke) separately such that at any given moment one plate stack is compressed, one plate stack is released, one plate stack is mid-compression, and one plate stack is mid-release. Heat-carrying fluid in the cold circuit may flow through the first heat exchanger, before being directed (e.g., by a series of valves or pumps) into the plate stack that is currently compressed. The compressed plate stack may then be moved to the released state, in turn absorbing heat from the heat-carrying fluid before the heat-carrying fluid within the now-released plate stack is returned to the cold circuit (e.g., to repeat the cycle). In contrast to the cold circuit, heat-carrying fluid in the hot circuit may flow through the second heat exchanger and be directed (e.g., by a separate series of valves or pump) into the plate stack that is currently released. The released plate stack may then be compressed (i.e., moved to the compressed stated), in turn releasing heat from the plate stack to the heat-carrying fluid before the heat-carrying fluid within the now-compressed plate stack is returned to the hot circuit (e.g., to repeat the cycle). The use of four plate stacks may allow both circuits to run continuously.

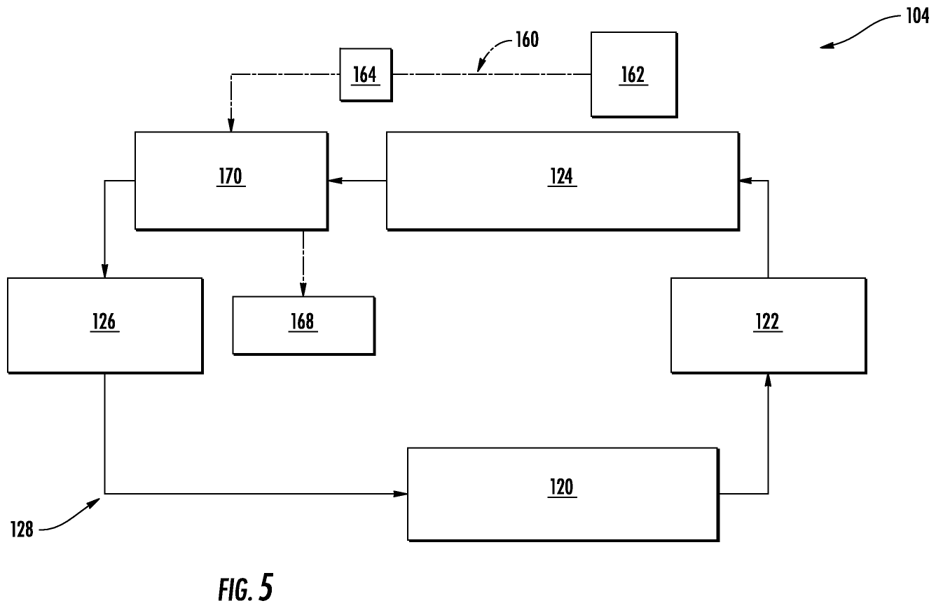

As shown in FIGS. 4 and 5, in addition to the sealed system or refrigerant circuit 128, air conditioning system 104 may include a water line 160 that is directed at the refrigerant circuit 128. Generally, the water line 160 may connect to any suitable water source 162 (e.g., municipal water supply, pump, well, etc.), such as would be provided at a campsite. Such water source connections are generally understood, especially in the context of recreational vehicles, may include, for instance, a hose threaded onto a spigot. Thus, the water line 160 may include at least one end that joins (e.g., directly or indirectly) to the water source 162 and another (e.g., opposite) end extending to or disposed within the modular enclosure 108.

When assembled, water line 160 is fluidly isolated from the refrigerant circuit 128—and any components thereof, such as evaporator 120, condenser 124, compressor 122, etc.—and thus does not permit mixing of water (e.g., from the water source 162) with refrigerant circulating within the refrigerant circuit 128. Nonetheless, as noted above, the water line 160 is directed at a portion of the refrigerant circuit 128. Thus, water line 160 may guide a flow of water from the water source 162 (i.e., cooling water flow) across the corresponding portion of the refrigerant circuit 128. Specifically, the cooling water flow may pass over an exterior surface of the refrigerant circuit 128, thereby drawing conducted heat from the refrigerant circuit 128 (and refrigerant therein). During use, the cooling water flow may advantageously increase the cooling capacity of the air conditioner system 104 within the modular enclosure 108, even at relative low volumes or flow rates of water.

In some embodiments, one or more water valves 164 may mounted on the water line 160 to selectively control the cooling water flow. For instance, a water valve 164 may be provided as any suitable electronic valve to selectively open-shut (e.g., based on one or more electric signals thereto) and, thus increase-decrease the volumetric flowrate of the cooling water flow. Optionally, water valve 164 may include a binary position valve (e.g., solenoid valve) that is movable only between an open position and a closed position. Additionally or alternatively, though, water valve 164 may include a variable position valve having a plurality of partially open positions to gradually increase or decrease the cooling water flow.

In certain embodiments, the water valve 164 is configured to selectively permit the cooling water flow based on refrigerant flow through the refrigerant circuit 128. In other words, the water valve 164 may be configured to adjust (e.g., open or close) based on if or how the refrigerant is flowing through the refrigerant circuit 128. For instance, the water valve 164 may be configured to open only when (e.g., be contingent on) an active refrigerant flow through the refrigerant circuit 128. Similarly, the water valve 164 may be configured to close if or when no active refrigerant flow is provided. In turn, the water valve 164 may notably avoid providing a cooling water flow when the refrigerant circuit 128 is inactive.

Generally, the water valve 164 may be operably (e.g., electrically or wirelessly) connected to another portion of recreational vehicle 100 to detect the state of the refrigerant circuit 128 (e.g., directly or indirectly). For instance, the water valve 164 may be operably connected to the controller 118 or electrically connected to a common electrical circuit with another component (e.g., compressor 122) to detect one or more conditions in which an active refrigerant is present. In some embodiments, opening of the water valve 164 is tied to activation of the compressor 122. For instance, water valve 164 is configured to move to an open position in response to activation of the compressor 122 (e.g., activation being detected at the controller or on a common electrical circuit with the water valve 164). In additional or alternative embodiments, the water valve 164 may be configured to require (i.e., be contingent on) another detected condition. For instance, the water valve 164 may be configured to require detection of a predetermined ambient temperature threshold in order to move to an open position to permit the cooling water flow. Such a temperature threshold may be detected at one or more temperature sensors (e.g., thermistor or thermocouple) operably connected to the controller or water valve 164 (e.g., on the recreational vehicle 100 or at a wirelessly connected weather station), as would be understood. Thus, at ambient temperatures below the predetermined ambient temperature threshold, the water valve 164 may be held in the closed position, notably preventing excess water flow or the freezing of water line 160.

Turning especially to FIG. 4, as indicated above, the water line 160 is generally directed at the refrigerant circuit 128. In certain embodiments, the water line 160 is directed at the condenser 124 (e.g., the exterior surface coils or fins of the condenser 124) to guide the cooling water flow across an exterior of the condenser 124. Optionally, a water manifold 166 defining one or more spray apertures may be disposed on the water line 160 adjacent to the condenser 124. For instance, the water manifold 166 may be held above or beside the condenser 124. Water from the water manifold 166 may be projected or sprayed onto the condenser 124. Thus, when water is flowing through the water line 160, the cooling water flow (e.g., at least a portion thereof) may be ejected from the water manifold 166 and land on an exterior surface of the condenser 124 (e.g., before evaporating into the ambient air or flowing down from the condenser 124).

In certain embodiments a drip pan or drain 168 is provided (e.g., below the condenser 124). The drain 168 may define a channel or flow path that leads out of the modular enclosure 108. Thus, at least a portion of the cooling water flow may pass over the compressor 122 and then to the drain 168 before being guided out of the modular enclosure 108.

Turning especially to FIG. 5, and again as indicated above, the water line 160 is generally directed at the refrigerant circuit 128. In certain embodiments, the water line 160 is directed at a heat exchanger 170 (e.g., brazed heat exchanger having one or more fins extending from a conduit body) disposed on the refrigerant circuit 128. The heat exchanger 170 may be mounted, for instance, on a portion of the refrigerant circuit 128 apart from the evaporator 120 or the condenser 124. For instance, the heat exchanger 170 may be disposed over a portion of the refrigerant circuit 128 downstream of the condenser 124 and upstream of the evaporator 120. In other words, although the refrigerant circuit 128 may define a closed loop path for refrigerant through the refrigerant circuit 128, the heat exchanger 170 may be positioned along a portion of the closed loop that is between the condenser 124 and the evaporator 120 relative to the direction of refrigerant flow such that refrigerant flowing to the evaporator 120 must first flow from the condenser 124 and then through the heat exchanger 170 before reaching the evaporator 120 (e.g., in a single pass through the refrigerant circuit 128). Optionally, the heat exchanger 170 define a sealed water path over a portion of the refrigerant circuit 128 apar from the evaporator 120 or the condenser 124. In particular, the heat exchanger 170 may enclose an exterior segment of the refrigerant circuit 128 (e.g., pipe, tube, or conduit thereof) and thereby define the sealed water path across the refrigerant circuit 128 and outside of the path of refrigerant. Thus, when water is flowing through the water line 160, the cooling water flow (e.g., at least a portion thereof) may be contained over an exterior surface of the refrigerant circuit 128.

In certain embodiments a drip pan or drain 168 is provided (e.g., downstream from the heat exchanger 170). The drain 168 may define a channel or flow path that leads out of the modular enclosure 108. Thus, at least a portion of the cooling water flow may pass through the heat exchanger 170 and then to the drain 168 before being guided out of the modular enclosure 108.

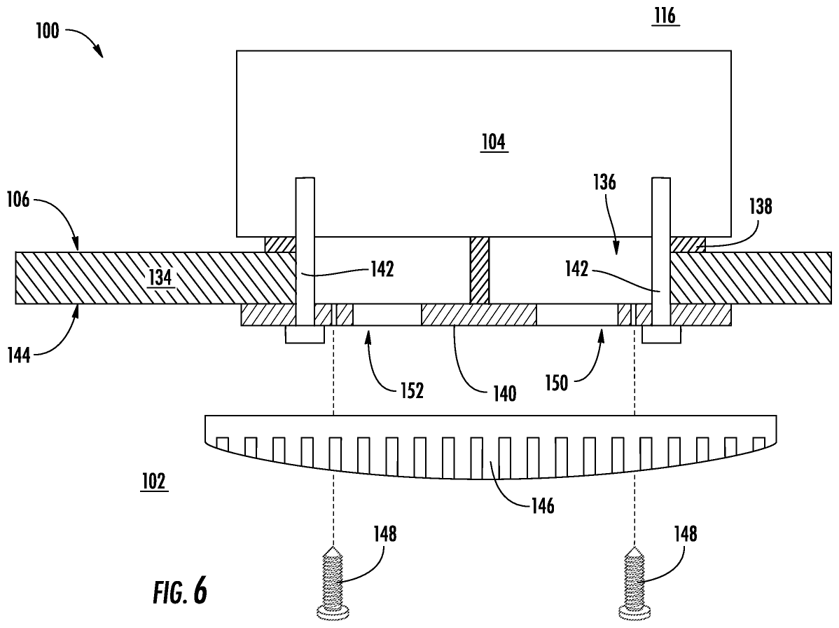

FIG. 6 provides a side schematic view of air conditioner system 104 mounted on a ceiling 134 of recreational vehicle 100. As explained above, air conditioning system 104 is mounted to outer surface 106 of ceiling 134. As illustrated in FIG. 6, air conditioner 104 is seated over an opening 136 within ceiling 134, e.g., to cover opening 136. In addition, a gasket 138 may be positioned between the air conditioner 104 and ceiling 134, e.g., to provide an airtight seal in prevent outside dirt and debris from passing into passenger compartment 102 through opening 136. Air conditioner 104 may be secured to ceiling 134 by mounting an indoor panel 140 within passenger compartment 102 and passing a plurality of bolts 142 or other suitable mechanical fasteners through indoor panel 140 and into air conditioner 104. According to an exemplary embodiment, indoor panel 140 is a substantially rigid metal plate that has one or more apertures for receiving bolts 142. As bolts 142 are tightened, air conditioner 104 is drawn firmly onto outer surface 106, thereby compressing gasket 138 and creating a seal with ceiling 134. Simultaneously, indoor panel 140 is urged firmly against an inner surface 144 of ceiling 134 to secure air conditioner 104 in place.

In optional embodiments, air conditioner 104 may further include an indoor grill 146 that is positioned over indoor panel 140. For example, indoor grill 146 may be mounted on inner surface 144 of ceiling 134 of recreational vehicle 100, e.g., within an interior or passenger compartment 102 of recreational vehicle 100. As shown, indoor grill 146 may be secured directly to indoor panel 140 using one or more mechanical fasteners 148. Although indoor panel 140 and indoor grill 146 are illustrated herein as two separate components, it should be appreciated that according to exemplary embodiments a single component may replace both indoor panel 140 and indoor grill 146. In addition, these components may be formed from any suitable material and may have any suitable shape, configuration, and mounting mechanisms.

Indoor grill 146 may overlay and hide components of air conditioner 104 to provide a pleasant cosmetic appearance for air conditioner 104 when viewed from passenger compartment 102. In addition, indoor grill 146 may facilitate filtering air circulated through the air conditioner 104. For example, indoor grill 146 may also include perforated sections to allow air to flow through indoor grill 146. For example, indoor grill 146 and indoor panel 140 may include an air inlet 150 and an air outlet 152. Air inlet and outlets 150, 152 may be separate from each other on indoor panel 140. Air from within passenger compartment 102 of recreational vehicle 100 may flow through indoor grill 146 and indoor panel 140 via air inlet 150, and such air may be treated (e.g., heated or cooled) by a sealed system of air conditioner 104 (see, e.g., FIGS. 2 through 5), and the treated air may then flow back into the passenger compartment 102 through indoor grill 146 and indoor panel 140 via air outlet 152.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A recreational vehicle air conditioner to mount over an air inlet defined through a roof of a recreational vehicle, the recreational vehicle air conditioner comprising:
a modular enclosure;
a refrigerant circuit mounted within the modular enclosure, the refrigerant circuit comprising an evaporator; and
a water line directed at the refrigerant circuit in fluid isolation from the evaporator to guide a cooling water flow across a portion of the refrigerant circuit apart from the evaporator within the modular enclosure.

2. The recreational vehicle air conditioner of claim 1, wherein the refrigerant circuit further comprises a condenser mounted within the modular enclosure apart from the evaporator, wherein the water line is directed at the condenser to guide the cooling water flow across an exterior of the condenser.

3. The recreational vehicle air conditioner of claim 1, further comprising a heat exchanger defining a sealed water path over a portion of the refrigerant circuit apart from the evaporator.

4. The recreational vehicle air conditioner of claim 3, wherein the refrigerant circuit further comprises a condenser mounted within the modular enclosure apart from the evaporator, wherein the heat exchanger disposed over the portion of the refrigerant circuit downstream of the condenser and upstream of the evaporator.

5. The recreational vehicle air conditioner of claim 1, further comprising a water valve mounted on the water line to selectively control the cooling water flow.

6. The recreational vehicle air conditioner of claim 5, wherein the water valve configured to selectively permit the cooling water flow based on refrigerant flow through the refrigerant circuit.

7. The recreational vehicle air conditioner of claim 6, wherein the refrigerant circuit further comprises a compressor mounted the modular enclosure to selectively motivate the refrigerant flow, and wherein the water valve is configured to move to an open position in response to activation of the compressor.

8. The recreational vehicle air conditioner of claim 5, wherein the water valve is configured to require detection of a predetermined ambient temperature threshold in order to move to an open position to permit the cooling water flow.

9. The recreational vehicle air conditioner of claim 1, wherein the modular enclosure is positioned at least partially over the air inlet.

10. A recreational vehicle comprising:
a ceiling defining an opening;
a ceiling-mount indoor panel defining an air inlet and an air outlet;
a modular enclosure mounted to the ceiling-mount indoor panel;
a refrigerant circuit mounted within the modular enclosure, the refrigerant circuit comprising an evaporator; and
a water line directed at the refrigerant circuit in fluid isolation from the evaporator to guide a cooling water flow across a portion of the refrigerant circuit apart from the evaporator within the modular enclosure.

11. The recreational vehicle of claim 10, wherein the refrigerant circuit further comprises a condenser mounted within the modular enclosure apart from the evaporator, wherein the water line is directed at the condenser to guide the cooling water flow across an exterior of the condenser.

12. The recreational vehicle of claim 10, further comprising a heat exchanger defining a sealed water path over a portion of the refrigerant circuit apart from the evaporator.

13. The recreational vehicle of claim 12, wherein the refrigerant circuit further comprises a condenser mounted within the modular enclosure apart from the evaporator, wherein the heat exchanger disposed over the portion of the refrigerant circuit downstream of the condenser and upstream of the evaporator.

14. The recreational vehicle of claim 10, further comprising a water valve mounted on the water line to selectively control the cooling water flow.

15. The recreational vehicle of claim 14, wherein the water valve configured to selectively permit the cooling water flow based on refrigerant flow through the refrigerant circuit.

16. The recreational vehicle of claim 15, wherein the refrigerant circuit further comprises a compressor mounted the modular enclosure to selectively motivate the refrigerant flow, and wherein the water valve is configured to move to an open position in response to activation of the compressor.

17. The recreational vehicle of claim 14, wherein the water valve is configured to require detection of a predetermined ambient temperature threshold in order to move to an open position to permit the cooling water flow.

18. The recreational vehicle of claim 10, wherein the modular enclosure is positioned at least partially over the air inlet.
